(19) United States
(12) Patent Application Publication
(10) Pub. No.: US 2025/0273194 A1
(43) Pub. Date: Aug. 28, 2025

(54) MULTI-LINGUAL TEXT-TO-SPEECH CONTROLLING

(71) Applicant: Murf, Inc., Salt Lake City, UT (US)

(72) Inventors: Shrikant Venkataramani, Karnataka (IN); Md Ashfaque Khalid, Bengaluru (IN); Batturi Bharath Kumar, Karnataka (IN); Ankur Edkie, Karnataka (IN); Oytun Turk, Salt Lake City, UT (US)

(21) Appl. No.: 19/060,542

(22) Filed: Feb. 21, 2025

Related U.S. Application Data
(60) Provisional application No. 63/556,991, filed on Feb. 23, 2024.

(51) Int. Cl. G10L 13/033; G06F 40/58; G10L 13/08

(52) U.S. Cl. CPC G10L 13/0335; G06F 40/58; G10L 13/08

(57) ABSTRACT

Methods, systems, and apparatus, including computer programs encoded on computer storage media, for performing text-to-speech modeling. In some implementations, a computer device receives input text in a first language to convert to a desired speech in a second language. The computer device receives one or more criteria for modifying the desired speech and converts the input text to a desired text in the second language. The computer device generates audio representations of the desired text in the second language and predicts, for each of the audio representations of the desired text and using the one or more received criteria, a pitch value and a duration value. The computer device generates the desired output speech using the predicted pitch value and the predicted duration value for each of the audio representations and provides the desired speech for output.

### CROSS-REFERENCE TO RELATED APPLICATION

This application claims the benefit of U.S. Provisional Application No. 63/556,991, filed on Feb. 23, 2024, the contents of which are incorporated by reference herein.

### TECHNICAL FIELD

This specification relates to text-to-speech modeling.

### BACKGROUND

Text-to-speech (TTS) systems can artificially produce human speech from written or typed text. Such systems can assist individuals with poor eyesight, people in locations where reading of text is not possible, and people who prefer to hear text spoken rather than reading the text. In some cases, the TTS system can output audible human speech from written text in any desired language. This allows individuals to hear the sounds of pronouncing the written text more accurately depending on the language.

### SUMMARY

The subject matter of this application is related to producing speech representative of input text. The speech representative of the input text can be generated according to any user specified criteria and output in any desired language. In some implementations, a system, such as a computer system, includes a text-to-speech (TTS) model that can receive input text and produce the corresponding speech. The TTS model can convert the input text into the corresponding speech in any desired language and provide controls for configuring characteristics of the corresponding speech.

In particular, the TTS model can offer comprehensive levels of control for producing desired characteristics of the speech. These levels of control are managed by various tools surfaced by the TTS model that allow a user or a device to adjust characteristics of the produced speech manually or automatically. These levels of control include, for example, controlling the speaking rate of the produced speech, controlling inflection points of various words of the produced speech, controlling the pause rate in the produced speech, controlling the pitch of the produced speech, and other types of controls. In this manner, the TTS model can be configured to produce speech having any desired characteristics from input text alone.

In some implementations, a system can train the TTS model to produce speech having any desired characteristics. Typically, a TTS model can convert input text into one or more features, such as phonemes. Phonemes can include one or more phones that represent any distinct speech sound or gesture that distinguish one word from another in a particular language. The TTS model can then predict durations for each of the phones. In order for the TTS model to be trained, the system can utilize an aligner that generates training data by aligning known speech with corresponding phones from that speech. Specifically, the aligner is trained to identify which part of speech corresponds to different phones. The TTS model is trained to produce phones of different durations which combine to produce the overall speech. The phone durations affect several aspects of the TTS speech output, such as, the rate of talking, rate of pauses taken while speaking, emotions, accents, and others. In this system, the aligner and the TTS model can be trained using similar training data, which ultimately simplifies the overall training process.

In one general aspect, a method performed by one or more computing devices includes: receiving input text in a first language to convert to a desired speech in a second language; receiving one or more criteria for modifying the desired speech; converting the input text to a desired text in the second language; generating audio representations of the desired text in the second language; predicting, for each of the audio representations of the desired text and using the one or more received criteria, a pitch value and a duration value; generating the desired output speech using the predicted pitch value and the predicted duration value for each of the audio representations; and providing the desired speech for output.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the first language and the second language are different.

In some implementations, receiving the one or more criteria for modifying the desired output speech includes receiving (i) a user specified pause rate, (ii) a user specified speaking rate, (iii) a user specified pitch, and (iv) a user specified sentence, word, or phoneme duration, for modifying the desired output speech.

In some implementations, generating audio representations of the desired text in the second language includes generating phoneme representations of the desired text in the second language.

In some implementations, predicting, for each of the audio representations of the desired text and using the one or more received criteria, the pitch value and the duration value comprises predicting, for each of the generated phoneme representations of the desired text and using the one or more received criteria, the pitch value and the duration value for the generated phoneme representations using a pitch predictor and a duration predictor of a text-to-speech model.

In some implementations, the text-to-speech model is trained using phoneme durations obtained using a residual vector quantization (RVQ) based aligner model.

In some implementations, generating the desired speech suing the predicted pitch value and the predicted duration for each of the audio representations comprises generating the desired speech by concatenating the predicted pitch value and the predicted duration value for each of the audio representations.

In some implementations, the method includes generating a linguistic context aligner that is configured to align TTS input phoneme sequences with large language model (LLM)-based linguistic context features, wherein the generating includes: providing, to the linguistic context aligner, the phoneme sequences as input; providing, to the linguistic context aligner, the linguistic context features as the input as a target; encoding, by the linguistic context aligner, the phoneme sequences as first embeddings; encoding, by the linguistic context aligner, the linguistic context features as second embeddings; extracting, by the linguistic context aligner, features from the first embeddings and the second embeddings; and determining, using an attention mechanism and a Viterbi decoder, an alignment between hidden representations of the phoneme sequences as the first embeddings and hidden representations of the linguistic context feature as the second embeddings.

The subject matter described in this specification can be implemented in various embodiments and may result in one or more of the following advantages. In some implementations, the system can improve the process for training TTS models and for training an aligner. During the training process, the system can generate training data used to train the TTS model and for training an aligner that aligns a known speech signal to phonemes produced from input text and obtains durations for every manner. In this manner, during application, the aligner operates directly on the phoneme sequence from the input text and representations of a speech signal in order to predict an alignment. Subsequently, the system utilizes an aligner to estimate phoneme durations, which are directly utilized for training the TTS model. Existing aligners and TTS systems operate on different representations of the same speech signal, which necessitates additional computation and storage. By utilizing an RVQ based aligner model and a TTS model that operate on common representations, e.g., common representations of the same speech signal, overall efficiency between these two models is improved.

Another advantage is the utilization of two versions of duration predictors in the TTS model and a pitch predictor. Typically, duration and pitch prediction allow for using a TTS model where the model predicts pitch and duration for every phone given the speaker's identity. However, by incorporating an additional duration predictor, more subjective aspects of speech can be controlled, such as speaking rate and pause rate. This can further be extended to emotion and other aspects of human speech. Ultimately, this allows for a more comprehensive controllability of the TTS model outputs and the use of a common representation between the aligner and the TTS models makes joint training possible and more efficient.

These techniques offer advantage of utilizing feature vectors extracted from large language models (LLMs) to guide a speech synthesis process. More specifically, the feature vectors extracted from LLMs can be used to train a linguistic context aligner. The linguistic context aligner can be configured to align TTS input phoneme sequences with LLM-based linguistic context features. Accordingly, the linguistic context aligner allows for the integration of linguistic context features in an automated and efficient manner. This allows the linguistic context aligner to be configured without relying on handwritten rules, complicated semantic analysis pipelines, and large lexica, which allow for scaling up with larger amounts of data in order to learn and identify more robust representations. This advantage enables the TTS model to improve the production of phonemes, words, and phrases, for a given sentence, which affect the pronunciation and prosody characteristics of speech.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system that converts text to speech according to user desired criteria.

FIG. 2 is a block diagram that illustrates an example of a residual vector quantization (RVQ) based aligner.

FIG. 3 is a block diagram that illustrates an example of a text-to-speech model.

FIG. 4 is a flow chart that illustrates an example process of converting text to speech according to user desired criteria.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

With the recent strides in generative modeling, there has been significant interest towards using these approaches for audio applications and other applications. This significant interest has led to several improvements in terms of quality and performance of recent text-to-speech (TTS) systems. In some implementations, TTS systems can operate in the following manner.

First, a system, such as a computer system, can construct a universal generative model that can transform a speech signal into a compact, vector-quantized (VQ) latent space and reconstruct back the original speech from this representation. Specifically, the system performs this process by constructing an encoder-decoder network and incorporating a series of residual vector quantization (RVQ) layers in between. The encoder-decoder network and the series of RVQ layers will be further described below. The system can train the encoder-decoder network and the series of RVQ layers as an auto-encoder to minimize the discrepancy between the input speech signal and its reconstruction. For example, the system can map speech waveforms into such RVQ spaces, which has been shown to offer significant levels of compression while reconstructing the speech waveforms to a high degree of similarity.

Second, the system can predict the RVQ tokens of a signal for a given input text (or phonemes that have been converted from input text) sequence that is desired to be synthesized. Often, the same text sequence can be mapped to different sets of RVQ tokens depending upon various characteristics. These various characteristics can include, for example, the speaker, the speaker's emotion, such as being angry, calm, or sad), the speaker's style of speech, such as advertising, meditation, or other, and other aspects of human speech.

In some implementations, the system can execute an iterative fitting procedure to predict the RVQ tokens in a zero-shot setting. A zero-shot setting is one in which the system has not analyzed the speaker's recordings before during training. In some examples, one approach is for the system to utilize a series of latent diffusion layers that successively add increasing amounts of Gaussian noise to the RVQ tokens until the RVQ tokens' structure is completely degraded. Here, the synthesis process can begin with the system drawing a sequence of random samples from a normalized Gaussian distribution and subsequently predicting the RVQ tokens, given the input text and an identification of the speaker.

In some examples, another approach is for the system to utilize an iterative parallel decoding (IPD) approach. During training, IPD models can receive the input text sequence and a masked version of the RVQ tokens as the input and predict the masked RVQ tokens directly. During application of the TTS model, the IPD model is given a text sequence and a fully masked RVQ sequence. The model can perform a series of un-masking steps thereby refining the output at each step. In some cases, IPD based approaches have been shown to achieve impressive performance for text-conditioned image synthesis, music synthesis/generation, and TTS systems.

In some implementations, TTS models can be used in various applications. In some examples, the various application can include automatic dubbing, websites that provide text to speech synthesis, mobile phone applications that convert text to speech, televisions that stream movies or television shows with automatic dubbing capabilities, and any other applications that can perform speech synthesis or text-to-speech conversion. For example, given a scene from a movie or a television show, one goal of automatic dubbing is to replace the actor's speech with their translated versions from another language, without altering the rest of the audio, such as the ambient sound effects, the background music, and other noises. In this case and as will be illustrated below, the original language of the scene is referred to as the source language and the language of the dubbed speech is referred to as the target language.

One such approach to dub an actor's speech involves the following process. First, the system transcribes the original utterance or speech to obtain the underlying text. Next, the system translates the underlying text to the target language. Next, the system can synthesize the target language into a speech signal using the TTS model in the target language. In some examples, to perform the automatic dubbing, the system can utilize a well-translated version of the actor's utterance and we only restrict ourselves with using a TTS system to produce the dubbed speech from the translated text.

For automatic dubbing, the system relies on a few key requirements when using TTS systems. These key requirements include the following: the dubbed speech in the target language has to be of the same duration as the original utterance. In order for the system to ensure the dubbed speech is of the same duration as the original utterance, the system is required to control the duration of the TTS output in a manner that is natural to the actor's speaking and pause rate. Similarly, the style of speech is also controlled by the prosody and variations in pitch. Accordingly, the ability to control the pitch of a sentence or sequence of words can be beneficial in this regard. In some examples, there is some text in which sentences are formed by combining one or more words from multiple languages, known as “code-switching”. With code-switching, the system should include the ability to synthesize speech jointly across multiple languages without altering the speaker identity.

Despite the recent advancements in TTS model technology, a few significant bottlenecks continue to hinder the widespread adoption of TTS systems for dubbing applications. In some examples, users of such systems often require a high degree of controllability in terms of altering different aspects of human speech like pitch, speaking rates, and pause durations, to name a few examples, which customizations are not typically offered as features of the TTS model. Providing controllability for various customizations of the TTS model requires incorporating additional sub-networks into the model that primarily focus on predicting specific aspects of a speech signal. These additional sub-networks will be further described below.

For example, providing a pitch-control feature in the TTS model to the user requires incorporating a pitch-predictor (PP) network that predicts a phoneme or frame-level pitch contour. Similarly, providing explicit control over durations of a word in an utterance requires a duration predictor (DP) network to be included in the model to explicitly model phoneme-level durations. However, directly altering the phoneme durations of the dubbed speech also affects the naturalness of the speech. Thus, maintaining speech naturalness while altering the duration of the dubbed speech requires a duration prediction approach that takes into account the “speaking rate” and “pause rate” of the speaker.

Training such duration predictor networks also requires training an aligner model. The aligner model can be configured to align the speech signal to the phonemes and obtain a duration for every phoneme. Existing TTS models use aligners that operate on a different representation of the audio signal than the TTS model. This ultimately necessitates additional computation and storage. However, the use of the aligner and the corresponding TTS model described throughout this specification makes training more efficient since the aligner and the TTS are trained on the same representation.

Modeling long-term context, handling data sparsity, and improving robustness to phoneme prediction errors and mismatches in each language are additional challenges in multi-speaker/multi-language speech synthesis when the total amount, variability, and quality of training data across different speakers and language vary. Building a robust front-end for grapheme-to-phoneme (G2P) for relatively low-resourced languages and for languages that have complicated writing and pronunciation systems can require significant effort for each new language. To address the challenges in modeling long-term context and improve robustness in the synthesis method, the techniques described below employ pre-trained large language models (LLMs) that are integrated with self-learned rich representations of language.

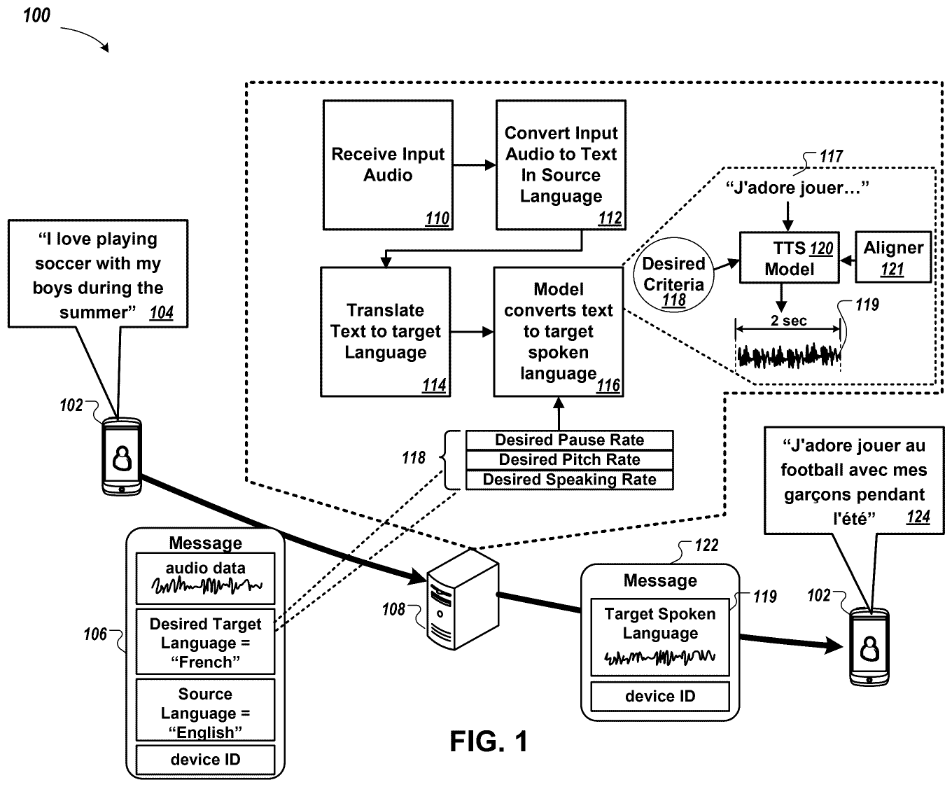

FIG. 1 is a block diagram of that illustrates an example of a system 100 that converts text to speech according to user desired criteria. The system 100 illustrates various components that enable performing automatic dubbing of a speech produced by client device 102. In particular, the system 100 includes a server 108 that can communicate with the client device 102. FIG. 1 illustrates various operations that can be performed in the sequence indicated, another sequence, with fewer components, and/or with more components. For instances, some of the sequence can be performed concurrently, in part or in whole, can be skipped, or can be performed in different orders.

The system 100 includes a server 108 that can communicate with the client device 102 over a network. The server 108 can include one or more computers or one or more servers connected locally or over a network, such as over a cloud-computing network. The network, in which the server communicates over with the client device 102, can include any network that communicates wired or wirelessly, e.g., the Internet, Bluetooth, Wi-Fi, Ethernet, or ZigBee, to name a few examples.

In some implementations, the client device 102 can provide an application that enables users to interact with and execute the text-to-speech process. The application can include, for example, a website, a mobile device application, an application on a personal computer, a streaming TV service, or another type of application. In some examples, client device 102 can display a video for a user and a user in the video may be speaking in a particular language.

As illustrated in the example of system 100, the user in the video of client device 102 may recite “I love playing soccer with my boys during the summer.” A user interacting with the client device 102 may desire to have the video spoken in another language, such as French, Chinese, Japanese, or another language. Moreover, the user interacting with the client device 102 may desire to adjust characteristics of the speech in the video, such as adjusting the pitch, word, sentence, phoneme durations, the speaking rate, the pause rate, and other characteristics. In some examples, the user interacting with the client device 102 can select the process of automatic dubbing to a desired language. In some examples, the client device 102 can be preconfigured to perform automatic dubbing to another language, e.g., dubbed from the English language to the French language, without a user instructing the client device 102 to execute this process.

In some implementations, in response to executing the automatic dubbing process, the client device 102 can transmit a message 106 to the server 108 to perform the automatic dubbing process. In some implementations, the processes performed by the server 108 to perform the automatic dubbing may be performed locally on the client device 102. In this later implementation, the client device 102 would not be required to transmit the message 106 to the server 108 but instead perform the automatic dubbing process locally.

In some implementations, the message 106 transmitted by the client device 102 can include various components. These components can include, for example, the audio data to be converted, the desired target language, the source language, a device identifier for the client device 102, and other characteristics. The other characteristics can represent the requested characteristics of the speech 118, which can include the desired pause rate, the desired pitch, the desired sentence, the desired word, the desired phoneme durations, and the desired speaking rate, to name a few examples.

In some examples, the audio data to be converted can include audio samples recorded or produced by the client device 102. The audio samples can be sampled at a high frequency rate to maintain high fidelity during the entirety of the text-to-speech conversion process. In some examples, the client device 102 can continuously stream the audio data to the server 108 to perform the text-to-speech conversion process for the entirety of the video or audio clip or clips. In some examples, the server 108 can provide the entirety of the video or audio clips to the client device 102 in the designated language with the desired characteristics prior to the initial playing of the video or audio clips on the client device 102. In this example, bandwidth can be preserved because the client device 102 does not need to send the message 106 to the server 108 with the audio data to be converted. Rather, the server 108 sends a message with the audio data tuned to the desired criteria of the user to the client device 102 without the client device 102 having to request for audio data to be converted.

In some examples, the desired target language can include a designator that identifies the target language. The designator can include a code, a number, or a string that defines the target language. Similarly, the source language can include a similar designator that identifies the source language. In some examples, the device identifier (ID) can include an identifier that identifies the device that transmitted the message. The identifier can be a MAC address, an IP address, a URL identifier, or another identifier that represents the device. The server 108 can use the device ID to determine which device sent the message 106 and which device to send the corresponding output from the text-to-speech conversion process.

During 110, the server 108 can receive the input audio. During 110, the server 108 can receive the message 106 from the client device 102 and extract the audio data from the message 106. The server 108 can store the extracted audio data in memory for ease of access and for processing the extracted audio data.

During 112, the server 108 can convert the input audio to text in source language. For example, the server 108 can determine from the message 106 that the source language is “English”. In response, the server 108 can perform one or more processes to transcribe or convert the input audio to text in the source language. In some examples, the server 108 can convert the spoken speech 104 of “I love playing soccer with my boys during the summer” to the textual representation of the spoken speech 104.

During 114, the server 108 can translate the text in the source language to the text in the desired target language. In some examples, the server 108 can determine from the message 106 that the designated language is “French”. In response, the server 108 can perform one or more processes to convert the text in the source language to the text in the target language. For example, the server 108 can convert the text in the source language of “I love playing soccer with my boys during the summer” to text in the target language of “J'adore jouer au football avec mes garçons pendant l'été”.

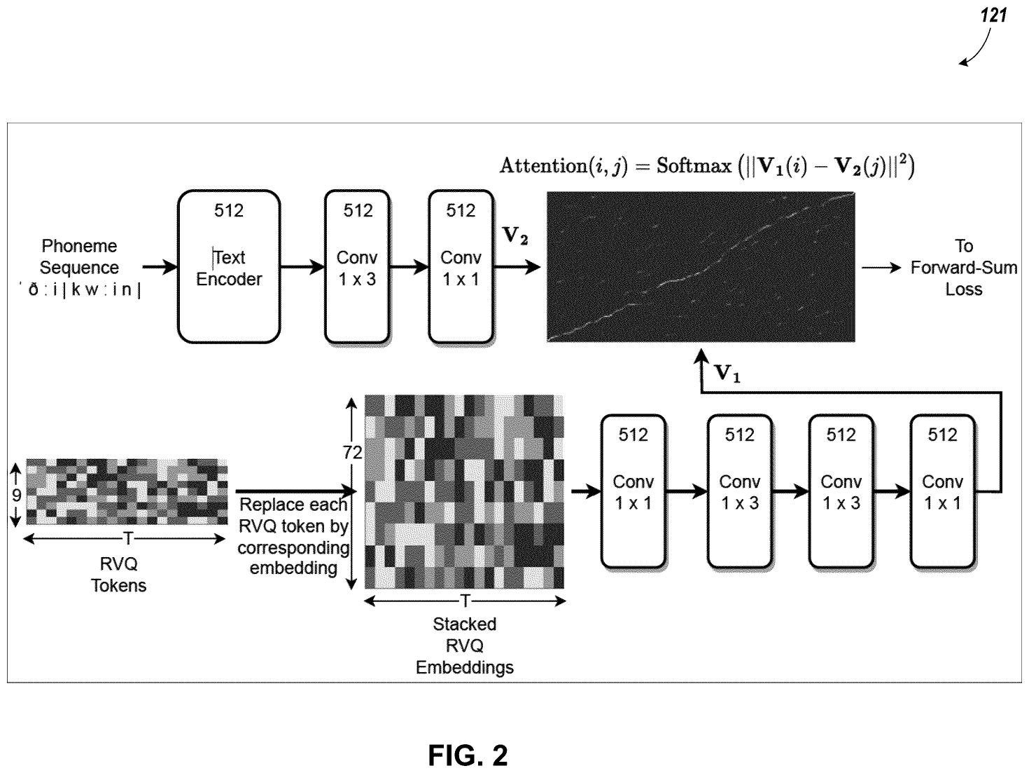

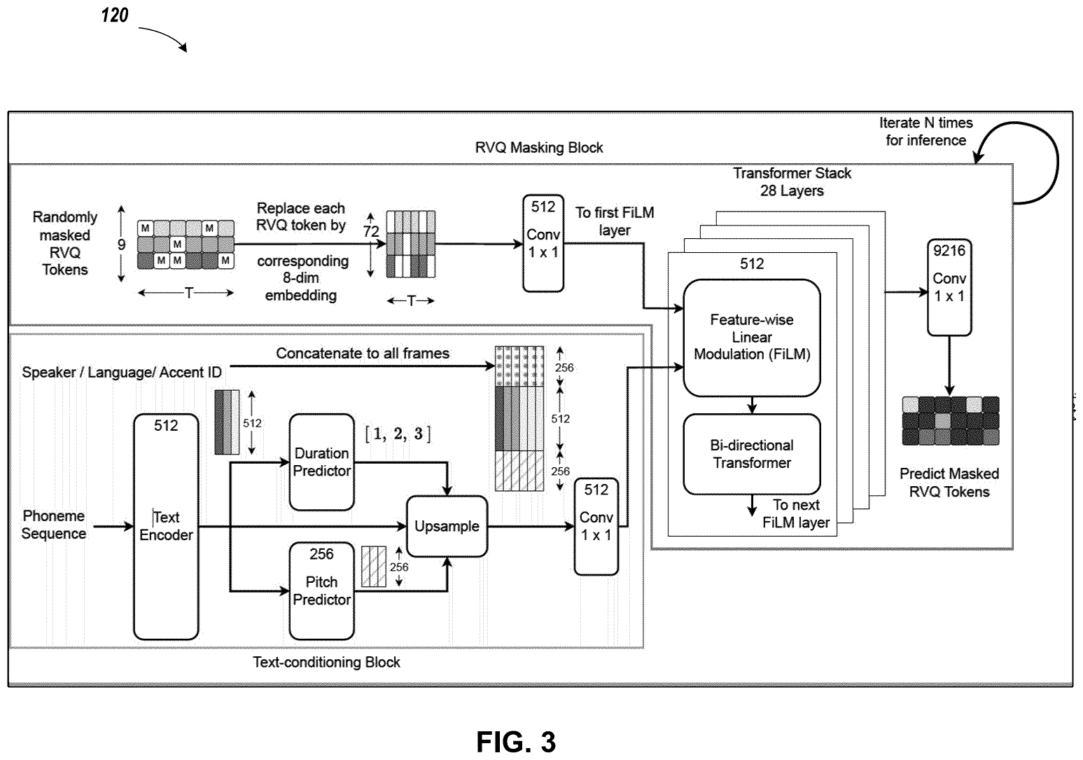

During 116, the server 108 utilizes a TTS model 120 to convert the text in the target language to the target spoken language. As illustrated in system 100, the TTS model 120 converts the text in the target language 117 to the target spoken language 119. More specifically, the TTS model 120 generates the target spoken language 119 using the text in the target language 117 and the requested characteristics of the speech 118. For example, the TTS model 120 produces the target spoken language 119 modified according to one or more of the desired pause rate, the desired pitch, the desired durations, and the desired speaking rate, to name some examples. The TTS model 120 is trained using phoneme data provided by an aligner 121. The processes that occur during 116 will be further described below with respect to FIGS. 2 and 3.

In some implementations, the TTS model 120 can ensure that certain aspects of the target spoken language 119 matches to the certain aspects of the audio data in the message 106. For example, the TTS model 120 can ensure the length of time of the target spoken language 119 matches to the length of time of the audio data in the message 106. As illustrated in system 100, the length of time of the target spoken language 119 is 2 seconds, which matches to the length of time of the audio data in the message 106. In addition to length, the TTS model 120 can ensure that the emotion and the style of the source speech and the TTS output remains as close as possible. Emotion and style of speech are maintained by selecting a TTS voice and style as close to the original speech as possible.

After producing the target spoken language 119, the server 108 can generate a message 122 to transmit to the client device 102. The message 122 can include the target spoken language 119 produced by the TTS Model 120, the device identifier for the client device 102 to receive the message 122, and other data for the client device 102. The client device 102 can receive the message 122 and extract the target spoken language 119. In response, the client device 102 can produce the target spoken language 119 in the same application in which the spoken speech 104 was produced. In some examples, the client device 102 can automatically dub the target spoken language 119 in a video or audio clip where the spoken speech 104 was originally produced. In some examples, the client device 102 can automatically overlay the target spoken language 119 in a video or replace the target spoken language 119 with the spoken speech 104. As illustrated in system 100, the client device 102 can produce the target spoken language 119 from a microphone in the spoken speech 124.

FIG. 2 is a block diagram that illustrates an example of a residual vector quantization (RVQ) based aligner 121. In particular, FIG. 2 illustrates the RVQ based aligner 121 that was previously illustrated in system 100. The RVQ based aligner 121 aids the TTS model 120 in the training process. In particular, the RVQ based aligner 121 simplifies the training process by developing an aligner network that operates directly on the phoneme sequence and the RVQ representation of a speech signal and predicts an alignment. Next, the RVQ based aligner 121 can estimate phoneme durations and provide the estimated phoneme durations for training the TTS model 120.

In some implementations, the RVQ based aligner 121 converts the RVQ tokens into an equivalent spectrogram-like representation by replacing them with their corresponding embedding vectors. The output sizes of each layer is given at the top of the layer, e.g., 512. For the convolutional layers, the corresponding kernel sizes are also shown in the blocks, e.g., 1×3 and 1×1. After training, the attention map computed between the text and RVQ representations gives the most likely alignment between the RVQ tokens and the phoneme sequence as shown. However, the attention map also highlights multiple highlighted RVQ tokens for each phoneme without considering the monotonic nature of the speech to text alignment. In some examples, the RVQ based aligner 121 utilizes a Viterbi algorithm on the soft-attention map to find the most-likely monotonically increasing path through the attention matrix. This hard-alignment can then be treated as the ground-truth alignment and used to obtain phoneme durations to train the TTS model 120.

In some implementations, aligning the speech signal and its corresponding text is integral in training a TTS model. These alignments enable a TTS model to learn and then predict phoneme durations to synthesize a speech signal. In some examples, autoregressive TTS models internally learn the alignments through an attention mechanism that is trained jointly with the rest of the TTS model. In some examples, non-autoregressive TTS models often rely on offline pre-trained TTS models to obtain the alignments and then compute the phoneme durations. In some cases, a generic aligner can be used to learn robust text-to-speech alignments, and train autoregressive and non-autoregressive TTS models. However, the above aligner models align the text to the Mel-spectrogram representation of the speech and not directly to the RVQ units. Thus, for RVQ based TTS models, the RVQ based aligner 121 additionally computes the Mel-spectrograms and that the Mel-spectrograms are computed at the same window and hop parameters as the RVQ tokens.

In some implementations, the RVQ based aligner 121 learns an alignment between the phonemes and the RVQ tokens of the corresponding speech recording. FIG. 2 illustrates an example architecture of the RVQ based aligner 121. The input phoneme sequence is passed through a text-encoder and a cascade of convolutional layers to obtain V₁∈R^{D×N}^{_{P}}. Here D=512 and Np denotes the output size of the convolutional layers and the number of phonemes respectively. R^{M×N} represents the space of real-valued matrices of size M×N. The text-encoder consists of a series of standard transformer blocks with relative positional encodings. The RVQ tokens include a stack of integer values where each integer value represents the index of the embedding vector that most likely represents the speech signal in the residual latent space.

In some examples, the RVQ based aligner 121 replaces the RVQ tokens by their corresponding embedding vectors and stack the embedding vectors to obtain a representation that can be treated as an alternative to the Mel-spectrogram. The alternative to the Mel-spectrogram is known as the RVQ-spectrogram. The RVQ-spectrogram is passed through a series of convolutional layers to obtain V₂∈R^{D×T} where T is the number of frames of the RVQ spectrogram. Here, the soft-alignment between the phoneme sequence and the RVQ spectrograms is obtained by computing the pairwise distances between the columns of V₁ and V₂ followed by a Softmax operation. Then, the RVQ based aligner 121 is trained using the Forward-Sum loss.

In some examples, the above soft-alignment is passed through a Viterbi decoding step to obtain the most likely monotonic path (also known as the “hard-alignment”). In some examples, the number of sequential frames of the RVQ-spectrogram that are mapped to the same given phoneme in the hard-alignment is stored as the duration of that phoneme. In some implementations, the RVQ based aligner 121 computes the phoneme durations for each speech-text pair in the training set.

In some examples, the context in which phonemes, words, and phrases are produced affects the pronunciation and prosody characteristics of speech. Generally, speech synthesis systems used handwritten rules, linguistic labels, and lexica to model the context. Machine learning techniques including decision trees and various context clustering strategies were developed early on to automate the modeling process while attempting to extract meaningful information from real data. These systems have typically been trained in a language-specific manner, making it difficult to generalize to multiple languages, as well as different accent and pronunciation characteristics within languages. With the advancement and success of large language modeling (LLM) approaches, the techniques described in system 100 can apply self-representation learning principles with vast amounts of data and can compute to progressively train more capable models that can represent context and to enable accurate predictions given that context.

The synthesis method, applied in system 100, takes advantage of self-representation learning in LLMs and integrates feature vectors extracted from such models as an additional conditioning to guide the speech synthesis process. In some cases, the LLMs can employ tokenization, which is different from phoneme-based modeling of languages. The aligner described here can be trained to align TTS input phoneme sequences with LLM-based linguistic context features. This alignment module can follow the principles of the RVQ aligner described in the previous section, taking phoneme sequences as input and linguistic context features as a target, encoding both features into corresponding embedding spaces, and passing the resulting vectors through convolutional layers to extract rich features. Finally, the hard alignment between the hidden representations of phonemes and linguistic features is determined using the attention mechanism and Viterbi decoding as described for the RVQ aligner. This alignment module allows for the integration of linguistic context features in an automated manner without relying on handwritten rules, complicated semantic analysis pipelines, and large lexica allowing for scaling up with larger amounts of data to learn more robust representations. In some cases, the synthesis method includes using the aligned linguistic features as conditioning for the RVQ token predictor and for the prosody modeling components.

FIG. 3 is a block diagram that illustrates an example of a text-to-speech (TTS) model 120. In particular, FIG. 2 illustrates the TTS model 120 that was illustrated in system 100. The TTS model 120 produces the desired speech from the input text or input phonemes produced from the input text. In particular, the TTS model 120 consists of two major blocks: the text-conditioning block and the RVQ masking block.

In some implementations, to control the pitch and durations of the synthesized speech output by the TTS model 120, the TTS model 120 includes a pitch prediction (PP) and duration prediction (DP) models. In some cases, the PP and DP models are trained to predict the pitch and duration of phoneme given the speaker identity. In some cases, the TTS model 120 incorporates an additional DP model that predicts phoneme durations based on the desired “speaking rate” and “pause rate”, to name a few examples. Accordingly, this specified criteria allows the TTS model 120 to adjust the duration of the TTS output speech in a manner that is natural to a speaker's original style.

In some cases, the long-term context modeling approach uses latent vectors from an LLM when predicting RVQ data from text. Specifically, the long-term context modeling approach extracts latent vectors from an LLM trained on many languages and adjusts the duration of these latent vectors according to predicted phoneme duration alignments. Then, the long-term context modeling approach uses the resulting vectors as an additional conditioning when predicting RVQ indices, duration, and pitch values from text. As the input rate and the types of inputs are different between LLMs and the TTS model 120 in general, the system 100 trains another aligner.

The other aligners are trained to learn to map the context vectors extracted from LLMs with the TTS phoneme sequence. In some examples, the architecture of the context feature-phoneme aligner is similar to the duration aligner, where phoneme sequences are the inputs and the context feature vectors are the output. In some examples, the context feature-phoneme aligner can use any LLM. In some examples, the context feature-phoneme aligner can use a collection of different LLMs to support the targeted languages as long as there is an interface to extract latent vectors by providing the text as input through the LLM model. Various types of LLMs can be incorporated into the context feature-phoneme aligner.

In some cases, some iterative parallel decoding (IPD) based approaches in use for TTS and music synthesis use a hierarchical approach where the RVQ tokens from the lower layers are predicted first. In some cases, the RVQ tokens are each predicted jointly using IPD. By predicting each RVQ token jointly, the TTS model 120 can utilize cross-codebook dependencies when synthesizing the audio signal.

In some implementations, the TTS model 120 is trained in a multi-language, multi-accent, multi-speaker setting where, the same model is used to synthesize speech across different speakers and languages. Specifically, the TTS model 120 is able to function with multi-languages, multi-accents, and multi-speakers by conditioning the model on speaker identifiers, language identifiers, and accent identifier vectors. This allows the TTS model 120 to synthesize speech in a different language or accent without changing the characteristics of a voice.

In some implementations, the output sizes of each layer of the TTS model is provided at the top of the layer, e.g., 512. For the convolutional layers, the corresponding kernel sizes are also shown in the blocks. The output of the text-conditioning block is given as the conditioning input to all the feature-wise linear modulation (FILM) layers in the transformer stack. The first FiLM layer takes the masked RVQ tokens as input while the other FiLM layers operate on the outputs of the preceding bidirectional transformer.

In some implementations, the TTS model 120 includes a text-conditioning block. In the text-conditioning block, the input phoneme sequence is passed through a text-encoder of size 512. The text-encoder includes a series of standard transformer blocks with relative positional encoding. The output of the text-encoder is text-sequence representation. The text-sequence representation is provided as input to the pitch predictor and the duration predictor that predict for every phoneme the pitch and duration values, respectively.

In some implementations, the TTS model 120 includes the ability to reduce the dynamic range of the pitch values output by the pitch predictor. For example, the pitch predictor can output the pitch values as log-values. The pitch predictor predicts the log pitch in a vectorized form and concatenates the log pitch to the phonemes.

In some implementations, the duration predictor is trained to predict integer duration values for every phoneme. For example, each phoneme includes the number of RVQ frames for which a phoneme is being uttered. After the duration predictor is the up-sample block. In some cases, the up-sample block is a projection layer that repeats a phoneme (and the concatenated pitch) as many times as the corresponding predicted duration. The output of the up-sample block is then passed through a convolutional layer and given as the conditioning input to all the FILM layers in the RVQ transformer stack in the TTS model 120.

In some implementations, the TTS model 120 includes the RVQ masking block. A randomly masked version of the speech RVQ tokens is provided as the input. The TTS model 120 replaces the speech RVQ tokens by their corresponding embeddings to obtain the RVQ-spectrogram, shown as the stacked RVQ embeddings. The TTS model 120 then resizes the RVQ-spectrogram appropriately using a convolutional layer and given as the input to the stack of bidirectional transformers in the FILM layers. The output of the last transformer stack is passed through a convolutional classifier layer (of size 9216). In some examples, the convolutional classifier layer can output the predicted masked RVQ tokens that were masked in the input in the form of a probability distribution, e.g., logits, over all possible candidates for that RVQ layer. This process is iterated N times during the inference or during the application of the TTS model 120.

In some implementations, the TTS model 120 can be trained using a variety of training data or training recordings. For example, the training recordings can be split into clips having a duration in the range of 3 to 20 seconds. Moreover, the system, such as server 108, can attach the text based-transcriptions to the split clips. In some examples, the server 108 can utilize a custom rule-based grapheme-to-phoneme (G2P) converter to convert the text transcriptions into their equivalent phoneme sequences. The server 108 can train the RVQ based aligner 121 and the TTS model 120 using the equivalent phoneme sequences.

Moreover, the server 108 can compute the pitch of these recordings at the same frame-rate as the RVQ tokens so that every frame of the RVQ spectrogram has a corresponding pitch value. To compute the pitch, the server 108 can utilize a variety of pitch prediction algorithms. Similarly, to obtain the RVQ tokens, the server 108 can utilize a variety of neural audio compression algorithms. Some examples of pitch prediction algorithms include time-based approaches such as YIN and probabilistic YIN. Some examples of pitch prediction algorithms include time and frequency domain based approaches such as robust algorithm for pitch tracking (RAPT) and Yet Another Algorithm for Pitch Tracking (YAAPT). Other examples of pitch prediction algorithms include neural network based approaches such as a convolutional representation for pitch estimation (CREPE). Some examples of neural audio compression algorithms include, for example, high fidelity neural audio compression (Encodec), soundstream which is an end-to-end neural audio codec, high-fidelity audio compression with improved residual vector quantization (RVQGAN), and Audiodec, which is an open-source streaming high-fidelity neural audio codec.

The sizes of the intermediate model outputs in the TTS model 120 are shown assuming the use of the compression algorithm. Here, the TTS model 120 includes a total of 9 RVQ layers and every RVQ layer has an associated embedding dictionary of 1024 vectors with an embedding size of 8. Thus, for every masked token, the TTS model 120 can predict the probabilities of 1024 possible choices. Considering that there are 9 levels of RVQ layers, the output dimensionality of the TTS model 120 becomes 1024×9=9216 when using the compression model. Other sizes are also possible. In some cases, the server 108 can train an RVQ based aligner 121 to learn the alignments between the speech and phoneme sequences and use it to estimate phoneme durations for the training clips.

In some implementations, the server 108 can utilize teacher-forcing to train the text-conditioning block of the TTS model. In particular, the server 108 trains the pitch and duration predictors to predict pitch and duration values, respectively, for every phoneme that are close to the ground-truth values estimated from the recordings. The rest of the model, e.g., RVQ masking block, is trained using the ground truth values for pitch and duration. The outputs of the pitch and duration predictors are used by the rest of the model only during inference or during application of the TTS model 120.

To train the RVQ masking block, the server 108 masks a random selection of RVQ tokens in the audio clips. These masked tokens are marked by the letter M in the illustration shown in FIG. 3. The number of such masked tokens is decided based on a masking factor r∈[0,1] drawn from a standard uniform distribution. The value r=1 unmasks all the RVQ tokens and r=0 indicates that all the tokens are masked. In addition, the server 108 enforces that r=0 for approximately 15% of the time. The RVQ masking block in the TTS model 120 is trained using the cross-entropy loss on the masked RVQ tokens only. Thus, the RVQ masking block can act as a refinement module that estimates a higher quality version of the audio than what is provided at its input.

In some implementations, the TTS model 120 performs various operations during its application or inference. During inference, an input text is to be synthesized using the TTS model 120 and converted into speech in a specific voice, language, and accent, to name a few examples. Initially, the TTS model 120 can the input text into its equivalent phoneme sequence using a G2P converter, for example. In the TTS model 120, the pitch and duration predictors predict the pitch and duration values for every phoneme in the sequence. The phoneme sequence and the corresponding pitch values and the speaker-ID's are then elongated to the desired lengths predicted by the duration predictor. The output of the text-conditioning block is then provided as the conditioning input to the first FiLM layer in the RVQ masking block. The text-conditioning block is a one-pass model where the input phoneme sequence passes through the model once and predicts an output.

On the other hand, the RVQ masking block is an iteratively used block during inference. In some examples, the TTS model 120 uses a particular process for the iterative decoding. First, the TTS model 120 starts the inference from a clean slate and assumes that all the RVQ tokens are completely masked at the iteration i=0. The TTS model 120 uses Yᵢ to denote the input to the RVQ masking block at iteration index i. Thus, every element of Y₀ is set to the mask index. Let N_{rvg} denote the total number of masked RVQ tokens in Y₀ and Nₛₜₑₚₛ denote the total number of iterative steps. The iterative process is applied in such a way that all the tokens are unmasked after Nₛₜₑₚₛ iterations. Thus, the number of tokens unmasked in every step can be given by

$$\frac{{N}_{rvq}}{{N}_{steps}} .$$

At an intermediate iteration i, some elements of Yᵢ will be masked while the others will be unmasked. During iteration i, for every masked element in Yᵢ, the TTS model 120 can predict a discrete probability distribution over all possible candidates. The TTS model 120 can estimate a token based on the predicted distribution and treat the corresponding probability value as the “confidence” score. The estimates are sorted according to their confidence scores and we retain

$$\frac{{N}_{rvq}}{{N}_{steps}}$$

of these. The estimates with the highest confidence scores are used to update Yᵢ and produce a more refined Yᵢ₊₁ which has fewer masked tokens than Yᵢ. The estimated tokens with lower confidence values are masked again and made eligible for re-estimation in iteration i+1.

In some implementations, the TTS model 120 can use the stochastic duration predictor for both pitch and duration estimation. In particular, the stochastic prediction models are trained to predict a continuous distribution over the log-values of the pitch and duration respectively. These log-values are mapped to a standard Gaussian distribution through a set of normalizing flows, conditioned on the text, and speaker/language/accent IDs. During inference or application of the TTS model 120, the TTS model 120 can draw a sequence of random values from the standard Gaussian distribution. Next, the TTS model 120 can append the corresponding text and speaker/language/accent details to the drawn sequence of random values and pass the appended data through the inverse flow layers to obtain the log-values of the predicted pitch and duration. In some cases, the TTS model 120 can convert the log durations to normal durations through an exponentiation step and truncated to the closest integer values. Then, the TTS model 120 can directly use the predicted log-pitch values.

In some implementations, the server 108 can train the TTS model 120 using two stochastic duration predictors. In addition to text and speaker/language/accent conditioning, the alternate duration predictor can use the average speech duration Dₛ and the average non-speech duration Dₙₛ as additional conditions. During training, given an audio clip, the corresponding phoneme sequence and the alignment, the server 108 can compute a phoneme-level pitch by averaging all frame-level pitch values that map to the same phoneme in the phoneme sequence.

These pitch values are used as the ground-truth values to train the pitch predictor in a teacher-forcing setup. A phoneme in the current phoneme sequence is considered to be a speech phoneme if its corresponding pitch value is non-zero. The server 108 can divide the phonemes in the phoneme sequence into speech and non-speech phonemes based on their corresponding average pitch. In some cases, the average speech duration Dₛ is the average duration computed over all the speech phonemes. The average non-speech duration Dₙₛ is computed in a similar manner using the non-speech phonemes. These non-speech phonemes can correspond to natural pauses, ambient sounds, human non-speech sounds, e.g., breaths, throat-clearing, etc. During inference, the duration predictor can offer the functionality to elongate or shorten the predicted speech in a manner that is natural to a speaker's speaking style by supplying the desired average duration for the speech and non-speech phonemes. This significantly enhances the TTS model 120's capabilities for dubbing applications where it becomes necessary to synthesize speech to fit within a desired duration while still sounding natural to the corresponding speaker.

In some implementations, the combination of model characteristics allows for several controllability features through the TTS model. Applications of controlling the TTS model include, for example, (i) controlling of sentence, word, and phoneme level emphasis, (ii) duration control of artificial intelligence dubbing, and (iii) providing voice guidance to control the audio output produced. The TTS model can be configured for user control and in various application scenarios.

In some implementations, the TTS model can be configured to control the sentence, word, and phoneme level emphasis. The phoneme-level duration and the pitch predictors allow for controlling the pitch and duration of the synthesized audio at the word or phoneme level. Since the duration and the pitch prediction models operate independently, the pitch and duration values can be modified independently of one another. For example, a user can control the values of the duration and pitch prediction models in the TTS model independent of one another. By modifying the durations and the pitch values, the TTS model allows for fine-grained control of the synthesized audio. This fine-grained control allows for emphasizing specific words or parts of a word as desired. The TTS model also provides the ability to control these characteristics of the entire sentence by shifting the overall pitch higher or lower and slowing down or speeding up the entire sentence.

In some implementations, the TTS model can allow for duration control for artificial intelligence (AI) dubbing. Using the TTS model for AI dubbing of a video requires synthesizing sentences and fitting the sentences with a very specific duration. This is necessary to avoid unnatural silences or overshoots in the dubbed video. By controlling the speaking rate-based duration predictor in the TTS model, the TTS model can synthesize natural sounding audio while maintaining the average speaking rate and pausing rate of the original speaker. This matches the duration of the synthesized audio to the original audio to a high level. In some cases, to eliminate the overshoots and undershoots and exactly match the durations, the TTS model can manually compress or elongate the silence portions and then the vowel sounds in the sentence.

In some implementations, users who interact with the TTS model can provide voice-based guidance to control the audio output produced. Here, the TTS model can receive voice audio from a user, and the TTS model can replicate the variations in prosody and speed from the guiding audio and transfer the replicated audio to output. The standard approach to achieve similar results is often to use voice conversion. The key drawback of using voice conversion is that it completely changes the accent of the TTS voice and can retain the vocal characteristics. Instead, the TTS model allows for guiding its output without changing the accent characteristics of the TTS voice. Given a guiding audio of the sentence, the RVQ based aligner can obtain the duration of every phoneme. Then, the system can compute the pitch contour and average the pitch values over a particular duration to obtain the pitch values of every phoneme. The system can supply these duration and pitch values to the TTS model to guide it to produce audio with the same prosody, stress and duration characteristics without altering the accent of the selected model speaker. The guiding audio can be a rendering of the sentence in any accent and the TTS model can transfer these characteristics to its synthesized output.

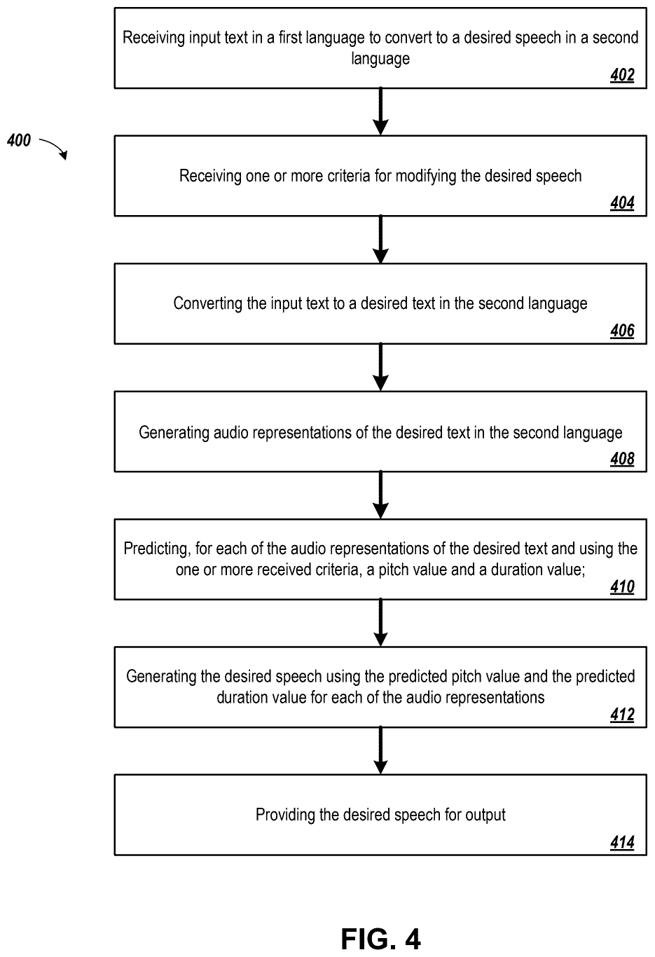

FIG. 4 is a flow chart that illustrates an example process 400 of converting text to speech according to user desired criteria. The process 400 can be performed by the server 108.

During 402, the server can receive input text in a first language to convert to a desired speech in a second language. In some cases, the first language and the second language can be different. For example, the first language may be “English” and the second language may be “French”. Other examples are also possible.

During 404, the server can receive one or more criteria for modifying the desired speech. The one or more criteria for modifying the desired speech can include receiving (i) a user specified pause rate, (ii) a user specified speaking rate, (iii) a user specified pitch, and (iv) a user specified sentence, word, phoneme duration, for modifying the desired output speech.

During 406, the server can convert the input text to a desired text in the second language. For example, the server can convert the input text in English to the desired text in French. Other examples are also possible.

During 408, the server can generate audio representations of the desired text in the second language. The audio representations of the desired text in the second language can include phoneme representations of the desired text in the second language.

During 410, the server can predict, for each of the audio representations of the desired text and using the one or more received criteria, a pitch value and a duration value. Predicting the pitch value and the duration value for each of the audio representations can include predicting, for each of the generated phoneme representation of the desired text and using the one or more received criteria, the pitch value and the duration value for the generated phoneme representations using a pitch predictor and a duration predictor of a text-to-speech model. Here, the text-to-speech model can be trained using phoneme durations produced by a residual vector quantization (RVQ) based aligner model.

During 412, the server can generate the desired output speech using the predicted pitch value and the predicted duration value for each of the audio representations. For example, the server can generate the desired output speech by concatenating the predicted pitch value and the predicted duration value for each of the audio representations.

During 414, the server can provide the desired speech for output. In some examples, providing the desired speech for output can include providing the desired speech to an application of a client device, a website, a television, a speaker, or another device for output.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1. A computer device implemented method comprising:
receiving input text in a first language to convert to a desired speech in a second language;
receiving one or more criteria for modifying the desired speech;
converting the input text to a desired text in the second language;
generating audio representations of the desired text in the second language;
predicting, for each of the audio representations of the desired text and using the one or more received criteria, a pitch value and a duration value;
generating the desired speech using the predicted pitch value and the predicted duration value for each of the audio representations; and
providing the desired speech for output.

2. The computer device implemented method of claim 1, wherein the first language and the second language are different.

3. The computer device implemented method of claim 1, wherein receiving the one or more criteria for modifying the desired speech comprises receiving (i) a user specified pause rate, (ii) a user specified speaking rate, (iii) a user specified pitch, and (iv) a user specified sentence, word, or phoneme duration, for modifying the desired speech.

4. The computer device implemented method of claim 1, wherein generating the audio representations of the desired text in the second language comprises generating phoneme representations of the desired text in the second language.

5. The computer device implemented method of claim 4, wherein predicting, for each of the audio representations of the desired text and using the one or more received criteria, the pitch value and the duration value comprises predicting, for each of the generated phoneme representations of the desired text and using the one or more received criteria, the pitch value and the duration value for the generated phoneme representations using a pitch predictor and a duration predictor of a text-to-speech model.

6. The computer device implemented method of claim 5, wherein the text-to-speech model is trained using phoneme durations obtained using a residual vector quantization (RVQ) based aligner model.

7. The computer device implemented method of claim 1, wherein generating the desired speech using the predicted pitch value and the predicted duration value for each of the audio representations comprises generating the desired speech by concatenating the predicted pitch value and the predicted duration value for each of the audio representations.

8. The computer device implemented method of claim 1, further comprising:
generating a linguistic context aligner that is configured to align TTS input phoneme sequences with large language model (LLM)-based linguistic context features, wherein the generating comprises:
providing, to the linguistic context aligner, the phoneme sequences as input;
providing, to the linguistic context aligner, the linguistic context features as the input as a target;
encoding, by the linguistic context aligner, the phoneme sequences as first embeddings;
encoding, by the linguistic context aligner, the linguistic context features as second embeddings;
extracting, by the linguistic context aligner, features from the first embeddings and the second embeddings; and
determining, using an attention mechanism and a Viterbi decoder, an alignment between hidden representations of the phoneme sequences as the first embeddings and hidden representations of the linguistic context feature as the second embeddings.

9. A system comprising:
one or more computers and one or more storage devices storing instructions that are operable, when executed by the one or more computers, to cause the one or more computers to perform operations comprising:
receiving input text in a first language to convert to a desired speech in a second language;
receiving one or more criteria for modifying the desired speech;
converting the input text to a desired text in the second language;
generating audio representations of the desired text in the second language;
predicting, for each of the audio representations of the desired text and using the one or more received criteria, a pitch value and a duration value;
generating the desired speech using the predicted pitch value and the predicted duration value for each of the audio representations; and
providing the desired speech for output.

10. The system of claim 9, wherein the first language and the second language are different.

11. The system of claim 9, wherein receiving the one or more criteria for modifying the desired speech comprises receiving (i) a user specified pause rate, (ii) a user specified speaking rate, (iii) a user specified pitch, and (iv) a user specified sentence, word, or phoneme duration, for modifying the desired speech.

12. The system of claim 9, wherein generating the audio representations of the desired text in the second language comprises generating phoneme representations of the desired text in the second language.

13. The system of claim 12, wherein predicting, for each of the audio representations of the desired text and using the one or more received criteria, the pitch value and the duration value comprises predicting, for each of the generated phoneme representations of the desired text and using the one or more received criteria, the pitch value and the duration value for the generated phoneme representations using a pitch predictor and a duration predictor of a text-to-speech model.

14. The system of claim 13, wherein the text-to-speech model is trained using phoneme durations produced by a residual vector quantization (RVQ) based aligner model.

15. The system of claim 9, wherein generating the desired speech using the predicted pitch value and the predicted duration value for each of the audio representations comprises generating the desired speech by concatenating the predicted pitch value and the predicted duration value for each of the audio representations.

16. The system of claim 9, further comprising:
generating a linguistic context aligner that is configured to align TTS input phoneme sequences with large language model (LLM)-based linguistic context features, wherein the generating comprises:
providing, to the linguistic context aligner, the phoneme sequences as input;
providing, to the linguistic context aligner, the linguistic context features as the input as a target;
encoding, by the linguistic context aligner, the phoneme sequences as first embeddings;
encoding, by the linguistic context aligner, the linguistic context features as second embeddings;
extracting, by the linguistic context aligner, features from the first embeddings and the second embeddings; and
determining, using an attention mechanism and a Viterbi decoder, an alignment between hidden representations of the phoneme sequences as the first embeddings and hidden representations of the linguistic context feature as the second embeddings.

17. One or more non-transitory computer-readable media storing software comprising instructions executable by one or more computers which, upon such execution, cause the one or more computers to perform operations comprising:
receiving input text in a first language to convert to a desired speech in a second language;
receiving one or more criteria for modifying the desired speech;
converting the input text to a desired text in the second language;
generating audio representations of the desired text in the second language;
predicting, for each of the audio representations of the desired text and using the one or more received criteria, a pitch value and a duration value;
generating the desired speech using the predicted pitch value and the predicted duration value for each of the audio representations; and
providing the desired speech for output.

18. The one or more non-transitory computer-readable media of claim 17, wherein the first language and the second language are different.

19. The one or more non-transitory computer-readable media of claim 17, wherein receiving the one or more criteria for modifying the desired speech comprises receiving (i) a user specified pause rate, (ii) a user specified speaking rate, (iii) a user specified pitch, and (iv) a user specified sentence, word, or phoneme duration, for modifying the desired speech.

20. The one or more non-transitory computer-readable media of claim 15, wherein generating the audio representations of the desired text in the second language comprises generating phoneme representations of the desired text in the second language.
